(19) United States
(12) Patent Application Publication
(10) Pub. No.: US 2005/0190943 A1
(43) Pub. Date: Sep. 1, 2005

(54) Motor vehicle microphone arrangement

(76) Inventors: Nick Disange, Coventry (GB); Simon Gladstone, Solihull (GB); Andrew Westwood, Birmingham (GB)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 11/014,063

(22) Filed: Dec. 16, 2004

(30) Foreign Application Priority Data
Jan. 10, 2004 (GB) 0400538.5

(51) Int. Cl. H04R 9/08; H04R 11/04; H04R 17/02

(52) U.S. Cl. 381/365; 381/361

(57) ABSTRACT

A microphone is arranged in a pillar trim of a motor vehicle. The pillar trim includes a trim panel which covers at least part of the A-pillar and is spaced from it. The microphone is fixed between the trim panel and the A-pillar, the trim panel having apertures arranged in the region of the microphone and a pair of lugs extending from the trim panel towards the A-pillar in order to clip the microphone in place. The trim panel is covered in cloth material in order to reduce the background noise arising from wind and vibration.

### FIELD OF THE INVENTION

The present invention relates to a microphone arrangement in a motor vehicle.

### TECHNICAL FIELD

In vehicles the uses of microphones are many, e.g. radio telephone devices, navigation system, voice commands etc. Conventionally, microphones are mounted in a variety of places such as on instrument panels in front of the driver's seat, overhead consoles and rear view mirrors. However, the microphone thus mounted is remote from the mouth of the driver and may not pick up voice sounds at a sufficient level of sensitivity.

One attempt to solve this problem is known from U.S. Pat. No. 6,111,964. This shows a microphone arrangement in which a base is installed on a pillar, an arm is pivotal relative to the base and a sound pick up unit is mounted at the end of the arm.

However, it is another problem with such a prior art arrangement that in the event of a vehicle collision the microphone may cause serious injuries to the driver.

It is an object of the present invention to provide a motor vehicle with an improved microphone arrangement where the above problems are alleviated.

### SUMMARY OF THE INVENTION

According to the invention there is provided a motor vehicle having a pair of A-pillars each of which is substantially covered by a respectively pillar trim fixedly mounted to the A-pillar, wherein at least one said pillar trim includes a trim panel which covers at least part of the A-pillar and is spaced from it, a microphone is fixed between the trim panel and the A-pillar and the trim panel has at least one aperture in the region of the microphone.

The said aperture may be located at a longitudinally central portion of the A-pillar. Preferably, the trim panel includes fastening means for the microphone so that when fixed it faces the said aperture and is directed substantially towards a seat for a user of the microphone.

The trim panel may be covered in cloth material. This helps to reduce the background noise arising from wind and vibration in use of the vehicle.

### BRIEF DESCRIPTION OF THE DRAWINGS

The invention will now be described by way of example with reference to the accompanying drawings of which:

FIG. 1 is a perspective view of part of the interior of a motor vehicle according to the present invention;

FIG. 2 is a cross-section on the line II-II of FIG. 1 showing a microphone installed on a trim panel;

FIG. 3 is a view in the direction of arrow “A” in FIG. 2 but with the microphone omitted; and

FIG. 4 is a similar view to the FIG. 3 with the microphone installed.

### DETAILED DESCRIPTION OF THE PREFERRED EMBODIMENTS

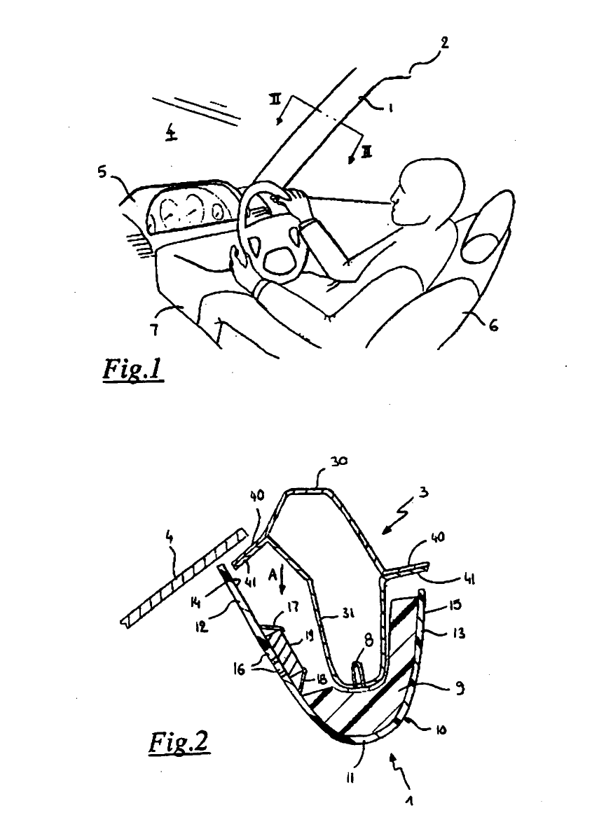

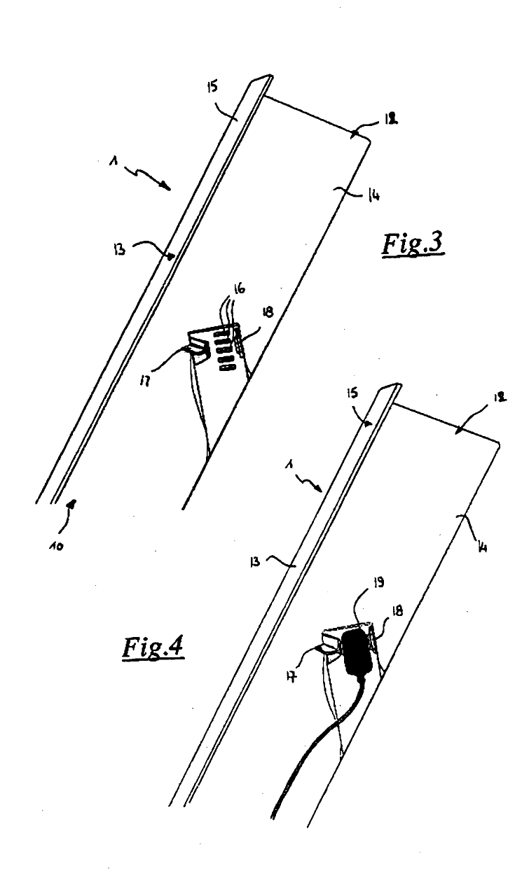

Referring to FIGS. 1 to 4, there is shown a passenger compartment of a motor vehicle and in particular a conventional pillar trim 1 which is employed to present an aesthetically pleasing appearance in the passenger compartment of the motor vehicle and to cover structural load bearing components.

Conventionally, the vehicle body includes a roof 2 and a pair of A-pillars 3 (only one shown) spaced laterally and extending downwardly and forwardly at an angle from a forward end of the roof 2. The vehicle body also includes a windshield 4 extending between the A-pillars 3. An instrument panel 5 extends laterally across the passenger compartment below the windshield 4 and seats are mounted to a floor 7 of the vehicle and spaced longitudinally from the instrument panel 5. In FIG. 1 only the driver's seat 6 is shown.

As shown in FIG. 2, the A-pillar 3 includes an exterior pressing 30 and an interior pressing 31. The exterior pressing 30 and interior pressing 31 include peripheral flange portions 40, 41 which are joined together by suitable means such as welding. The pillar trim 1, described above, includes a trim panel 10 fixedly mounted to the A-pillar 3 and spaced from it. The trim panel 10 extends along the entire length thereof. To that end, the panel trim 10 includes a fastening mechanism, which in this case, is a plurality of clips 8 disposed along its length.

The trim panel 10 conforms to the A-pillar 3 and is substantially U-shaped in cross-section and includes a central portion 11 and a pair of side portions, conveniently referred to first side portion 12 and second side portion 13, with the central portion 11 extending between the side portions 12, 13. The trim panel 10 also includes a number of energy absorbing ribs 9 spaced along the trim panel 10. The trim panel 10 is preferably formed as a one-piece injection moulded part of a plastics material.

The trim panel 10 of the pillar trim 1 in front of the driver's seat 6 has an interior surface 14 and an exterior surface 15, the first side portion 12, which is substantially directed towards the driver's seat 6, including several apertures 16 located appreciably in the middle part of the pillar trim 1, in order to be at the shorter distance to the mouth of a driver having an average height. A pair of lugs 17, 18, extend from the interior surface 14 towards the A-pillar 3 and act as fastening means for a microphone 19, in order to clip the microphone 19 to the pillar trim 1 facing the apertures 16. Alternatively, the microphone 19 may be fixed to the first side portion 12 of the trim panel by an adhesive or screws.

In use, the apertures 16 allow the microphone 19 to pick up voice sounds from the driver with a good level of sensitivity.

The microphone 19 may be part of a voice recognition system and connected to several audio devices, such as a navigation system, a climate systems, a phone, a radio, etc. in order to allow the driver to operate such devices by using simple voice commands.

The exterior surface 15 of the trim panel 10, i.e. opposite the A-pillar 3, is preferably covered or wrapped in a perforated vinyl, cloth or any other suitable material so that the background noise arising from wind and vibration, such as road vibration, windscreen noise and engine vibrations will be reduced.

Such a microphone arrangement offers the advantage of reducing wind noise and improves the performance of the microphone even at fast vehicle speeds, the voice signal remaining intelligible for the different audio devices. This is particularly effective if the vehicle has a removable roof (e.g. a convertible) or the side windows or a sunroof are open and the vehicle is driven at speed. The cloth covering allows the microphone to be invisible or barely perceptible to the driver and hence unwanted driver distraction is avoided. Also, by locating the microphone between the trim panel and the A-pillar, the trim panel 10 can performs its usual function of protecting the vehicle occupants from the unyielding surfaces of the A-pillar and there is no additional occupant hazard imposed by the microphone.

It will be appreciated that the microphone may be arranged at an angle to the A-pillar 3 in order to aim it towards the driver's seat.

1. A motor vehicle having a pair of A-pillars each of which is substantially covered by a respectively pillar trim fixedly mounted to the A-pillar, wherein at least one said pillar trim includes a trim panel which covers at least part of the A-pillar and is spaced from it, a microphone is fixed between the trim panel and the A-pillar and the trim panel has at least one aperture in the region of the microphone.

2. A motor vehicle of claim 1, wherein the microphone is located at a longitudinally central portion of the A-pillar.

3. A motor vehicle of claim 1, wherein the trim panel includes fastening means for the microphone so that when fixed it faces the said aperture and is directed substantially towards a seat for a user of the microphone.

4. A motor vehicle of claim 1, in which the trim panel is covered in cloth material.

5. A motor vehicle of claim 1, in which the microphone is associated with an audio device.
